(19) United States
(12) Patent Application Publication
(10) Pub. No.: US 2014/0365279 A1
(43) Pub. Date: Dec. 11, 2014

(54) INFORMATION MANAGEMENT DEVICE, INFORMATION MANAGEMENT METHOD, AND NON-TRANSITORY STORAGE MEDIUM

(71) Applicants: NEC Solution Innovators, Ltd., Tokyo (JP); NEC Corporation, Tokyo (JP)

(72) Inventors: Hajime Eda, Tokyo (JP); Yoshiaki Matsubara, Tokyo (JP); Kazuki Tsuji, Tokyo (JP); Mitsuteru Tanoue, Tokyo (JP)

(73) Assignee: NEC Corportion, Tokyo (JP)

(21) Appl. No.: 14/372,898

(22) PCT Filed: Jan. 17, 2013
(86) PCT No.: PCT/JP2013/000212

§ 371 Date: Jul. 17, 2014

(30) Foreign Application Priority Data
Jan. 18, 2012 (JP) 2012-008499

(51) Int. Cl. G06Q 10/06; G06F 17/24

(52) U.S. Cl. CPC G06Q 10/06395; G06F 17/246
USPC 705/7.41

(57) ABSTRACT

Provided is an information management device (10) that includes a matrix display unit (15) that displays a two-dimensional matrix table, displays some or all of required qualities required for a first commercial product and specification items associated with the first commercial product, as vertical direction elements, in a vertical column in the two-dimensional matrix table, and displays some or all of the required qualities required for the first commercial product and the specification items associated with the first commercial product, as horizontal direction elements, in a horizontal row in the two-dimensional matrix table, a relationship information reception unit (16) that receives an input of relationship information indicating strength of correspondence between the vertical direction element (required quality or specification item) and the horizontal direction element (required quality or specification item) with respect to a cell at an intersection between the vertical direction element and the horizontal direction element in the two-dimensional matrix table, and a relationship information storage unit (17) that stores the relationship information received by the relationship information reception unit (16) in association with the first commercial product.

### TECHNICAL FIELD

The present invention relates to an information management device, an information management method, and a program.

### BACKGROUND ART

Non-Patent Document 1 discloses an outline of quality function deployment (QFD). The QFD is a methodology which is conceived with the intent of effectively developing a new product. According to the method, first, customers' demands are collected by a method such as a questionnaire survey, and then the collected data is analyzed to extract qualities required for a new commercial product. For example, when the commercial product is a lighter, the required qualities can be expressed through the customers' points of view, such as “reliable ignition” or “ease of use”.

Thereafter, the required qualities are converted to quality elements. Specifically, the quality elements are extracted on the basis of the required qualities, and a two-dimensional matrix table (quality table) summarizing dependence between the required qualities and the quality elements is created. The quality elements can be expressed through the engineer's point of view, such as “durability” or “ignitability”. That is, the required qualities are the world of a market, the quality elements are the world of technology, and the conversion from the required qualities to the quality elements can be considered as the conversion from the world of the market to the world of the technology.

Thereafter, a function deployment table in which functions necessary for a target product are deployed is created, and a mechanism deployment table is created by deploying mechanisms for realizing the functions. Then, the tables are deployed in a unit and part deployment table for connecting the mechanisms to specific parts, and the like.

In addition, Patent Document 1 discloses a quality table summarizing a correspondence relationship between a required quality and a quality characteristic, a correspondence relationship between the required quality and a part, and a correspondence relationship between the quality characteristic and the part.

### RELATED DOCUMENT

### Patent Document

[Patent Document 1] Japanese Unexamined Patent Publication No. 2010-33530

### Non-Patent Document

[Non-Patent Document 1] Tadashi Ofuji, “Outline of quality function deployment (QFD)”, [online], Jan. 17, 2000 [searched on Dec. 22, 2011], the Internet <URL:http://techon.nikkeibp.co.jp/free/nmc/kiji/triz/kiji/kiji1/kiji001.html>

### DISCLOSURE OF THE INVENTION

In a case of a system of the related art, contents of a quality table which are capable of being created by a designer are limited. For example, in a case of the system of the related art, elements to be deployed in the quality table are determined in advance (for example, required qualities are deployed in a vertical direction and quality characteristics are deployed in a horizontal direction in a two-dimensional matrix table), and thus the designer has no choice but to create a quality table in a limited range (for example, a quality table showing only dependence between the required quality and the quality characteristic) in accordance with the format thereof.

However, the inventors have found out that there is dependence between the same elements, and have also found out that dependence between the same elements has to be considered in order to improve the accuracy of a process of converting certain elements to other elements.

Consequently, an object of the present invention is to provide a technique of supporting the creation of a quality table of QFD which is not present in the related art.

According to the present invention, provided is an information management device including: a required quality reception unit that receives inputs of required qualities which are one or a plurality of qualities required for a first commercial product; a required quality storage unit that stores the required qualities received by the required quality reception unit in association with the first commercial product; a specification item reception unit that receives inputs of one or a plurality of specification items associated with the first commercial product; a specification item storage unit that stores the specification items received by the specification item reception unit in association with the first commercial product; a matrix display unit that displays a two-dimensional matrix table, displays some or all of the one or plurality of required qualities stored in the required quality storage unit and the one or plurality of specification items stored in the specification item storage unit, as vertical direction elements, in a vertical column in the two-dimensional matrix table, and displays some or all of the one or plurality of required qualities stored in the required quality storage unit and the one or plurality of specification items stored in the specification item storage unit, as horizontal direction elements, in a horizontal row in the two-dimensional matrix table; a relationship information reception unit that receives an input of relationship information indicating strength of correspondence between the required quality and the specification item, strength of correspondence between the required qualities, or strength of correspondence between the specification items, with respect to a cell at an intersection between a first vertical direction element and a first horizontal direction element in the two-dimensional matrix table, in accordance with contents of the first vertical direction element and the first horizontal direction element; and a relationship information storage unit that stores the relationship information received by the relationship information reception unit in association with the first commercial product.

In addition, according to the present invention, provided is a program causing a computer to function as: a required quality reception unit that receives inputs of required qualities which are one or a plurality of qualities required for a first commercial product; a required quality storage unit that stores the required qualities received by the required quality reception unit in association with the first commercial product; a specification item reception unit that receives inputs of one or a plurality of specification items associated with the first commercial product; a specification item storage unit that stores the specification items received by the specification item reception unit, in association with the first commercial product; a matrix display unit that displays a two-dimensional matrix table, displays some or all of the one or plurality of required qualities stored in the required quality storage unit and the one or plurality of specification items stored in the specification item storage unit, as vertical direction elements, in a vertical column in the two-dimensional matrix table, and displays some or all of the one or plurality of required qualities stored in the required quality storage unit and the one or plurality of specification items stored in the specification item storage unit, as horizontal direction elements, in a horizontal row in the two-dimensional matrix table; a relationship information reception unit that receives an input of relationship information indicating strength of correspondence between the required quality and the specification item, strength of correspondence between the required qualities, or strength of correspondence between the specification items, with respect to a cell at an intersection between a first vertical direction element and a first horizontal direction element in the two-dimensional matrix table, in accordance with contents of the first vertical direction element and the first horizontal direction element; and a relationship information storage unit that stores the relationship information received by the relationship information reception unit in association with the first commercial product.

In addition, according to the present invention, provided is an information management method executed by a computer, the method comprising: a matrix display step of displaying a two-dimensional matrix table, displaying some or all of required qualities which are one or a plurality of qualities required for a first commercial product and one or a plurality of specification items associated with the first commercial product, as vertical direction elements, in a vertical column in the two-dimensional matrix table, and displaying some or all of the one or plurality of required qualities and the one or plurality of specification items, as horizontal direction elements, in a horizontal row in the two-dimensional matrix table; a relationship information reception step of receiving an input of relationship information indicating strength of correspondence between the required quality and the specification item, strength of correspondence between the required qualities, or strength of correspondence between the specification items, with respect to a cell at an intersection between a first vertical direction element and a first horizontal direction element in the two-dimensional matrix table, in accordance with contents of the first vertical direction element and the first horizontal direction element; and a relationship information storage step of storing the relationship information received in the relationship information reception step in association with the first commercial product.

According to the present invention, it is possible to create a quality table of QFD which is not present in the related art.

### BRIEF DESCRIPTION OF THE DRAWINGS

The above-described objects, other objects, features and advantages will be further apparent from the preferred exemplary embodiments described below, and the accompanying drawings as follows.

FIG. 1 shows an example of a functional block diagram of an information management device according to a first exemplary embodiment.

FIG. 2 shows an example of a screen displayed by the information management device according to this exemplary embodiment.

FIG. 3 shows an example of a screen displayed by the information management device according to this exemplary embodiment.

FIG. 4 shows an example of a functional block diagram of an information management device according to a second exemplary embodiment.

FIG. 5 shows an example of a two-dimensional matrix table displayed by a matrix display unit.

FIG. 6 shows an example of a functional block diagram of an information management device according to a third exemplary embodiment.

FIG. 7 shows an example of input value restriction information stored in a restriction information storage unit.

FIG. 8 shows an example of a functional block diagram of an information management device according to a fourth exemplary embodiment.

FIG. 9 shows an example of information stored in a part specification relationship information storage unit.

FIG. 10 shows an example of information stored in a part information storage unit.

FIG. 11 shows an example of information capable of being stored by an information management device.

### DESCRIPTION OF EXEMPLARY EMBODIMENTS

Hereinafter, exemplary embodiments of the present invention will be described with reference to the accompanying drawings.

Meanwhile, a system according to this exemplary embodiment is realized by an arbitrary combination of hardware and software on the basis of a CPU, a memory, a program loaded into the memory (including a program previously stored in the memory when shipping out the device and a program downloaded from a storage medium such as a CD, or a server or the like on the Internet) of an arbitrary computer, a storage unit such as a hard disk that stores the program, and an interface for network connection. In addition, one skilled in the art can understand that various modifications can be made to examples for realizing the method and device.

In addition, functional block diagrams used in describing this exemplary embodiment show function-based blocks rather than hardware-based configurations. In the functional block diagrams, although description is given such that each device is realized by one piece of equipment, a realizing unit thereof is not limited thereto. In other words, each device may be configured to be physically or logically separated.

### First Exemplary Embodiment

First, an outline of an information management device according to this exemplary embodiment will be described.

The information management device according to this exemplary embodiment has a function of supporting the development of a new commercial product using a technique of QFD and managing information (quality table of QFD, and the like) which is used in the development stage in association with the developed new commercial product. For example, the information which is managed can be used later to develop a similar commercial product (variation commercial product) or to examine the influence of change from component parts of the commercial product to other parts.

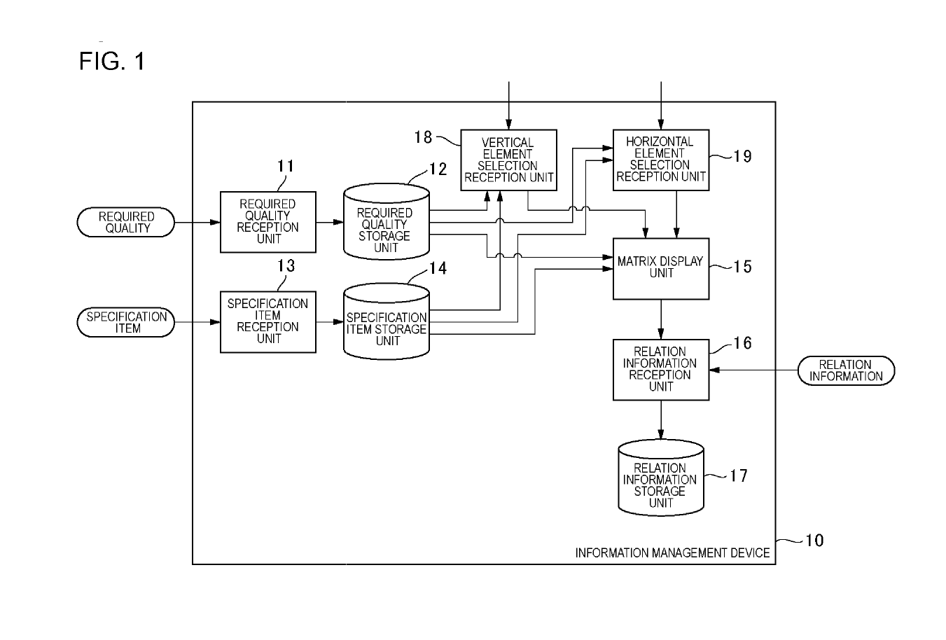

FIG. 1 shows an example of a functional block diagram of an information management device 10 according to this exemplary embodiment. As shown in the drawing, the information management device 10 includes a required quality reception unit 11, a required quality storage unit 12, a specification item reception unit 13, a specification item storage unit 14, a matrix display unit 15, a relationship information reception unit 16, and a relationship information storage unit 17. Meanwhile, the information management device 10 may further include a vertical element selection reception unit 18 and a horizontal element selection reception unit 19. Hereinafter, the units will be described.

The required quality reception unit 11 receives inputs of one or a plurality of qualities (required qualities) which are required for a first commercial product (commercial product which is newly developed). The “required quality” used herein is a term synonymous with the “required quality” disclosed in Non-Patent Document 1. For example, when the first commercial product is a multifunction machine (hereinafter, simply referred to as a “multifunction machine”) which has a plurality of functions such as a copier, a printer, an image scanner, and a facsimile machine, “high-speed printing”, “comfortable scanning”, “smooth operation”, “vivid high image quality” and the like are considered as the required qualities. Such required qualities (hereinafter, referred to as “first required qualities”) which are required for the first commercial product can be extracted using a technique disclosed in Non-Patent Document 1. An operation of extracting the first required qualities is performed by a person. The required quality reception unit 11 receives inputs of the first required qualities using any input device such as a keyboard, a touch panel display, a scanner, or a microphone.

The required quality storage unit 12 stores the first required qualities received by the required quality reception unit 11 in association with the first commercial product. For example, the first commercial product is given identification information such as a commercial product number, and the required quality storage unit 12 stores the first required qualities in association with the identification information.

The specification item reception unit 13 receives inputs of one or a plurality of specification items associated with the first commercial product. The specification items are items to be considered in designing a commercial product, and are items and the like which are described in a so-called commercial product specification sheet. The specification items associated with the first commercial product (hereinafter, referred to as “first specification items”) are specification items to be considered in designing the first commercial product in order to realize the first required qualities stored in the required quality storage unit 12. The first specification items may include general specification items which are considered in designing the first commercial product. For example, the first specification items may be extracted with reference to past design examples in the same type of commercial product as the first commercial product. Alternatively, the first specification items may be extracted from designer's own experience on the basis of the first required qualities stored in the required quality storage unit 12. In addition, the first specification items may be a combination thereof. For example, when the first commercial product is a multifunction machine, “HDD capacity”, “color compatibility”, “reading resolution”, “writing resolution”, and the like are considered as the first specification items. An operation of extracting such first specification items is performed by a person. The specification item reception unit 13 receives inputs of the first specification items using any input device such as a keyboard, a touch panel display, a scanner, or a microphone.

The specification item storage unit 14 stores the first specification items received by the specification item reception unit 13 in association with the first commercial product. For example, the first commercial product is given identification information such as a commercial product number, and the specification item storage unit 14 stores the first specification items in association with the identification information.

The matrix display unit 15 displays a two-dimensional matrix table on a display. Some or all of the one or plurality of first required qualities stored in the required quality storage unit 12 and the one or plurality of first specification items stored in the specification item storage unit 14 are displayed as vertical direction elements in a vertical column in the two-dimensional matrix table. In addition, some or all of the one or plurality of first required qualities stored in the required quality storage unit 12 and the one or plurality of first specification items stored in the specification item storage unit 14 are displayed as horizontal direction elements in a horizontal row in the two-dimensional matrix table.

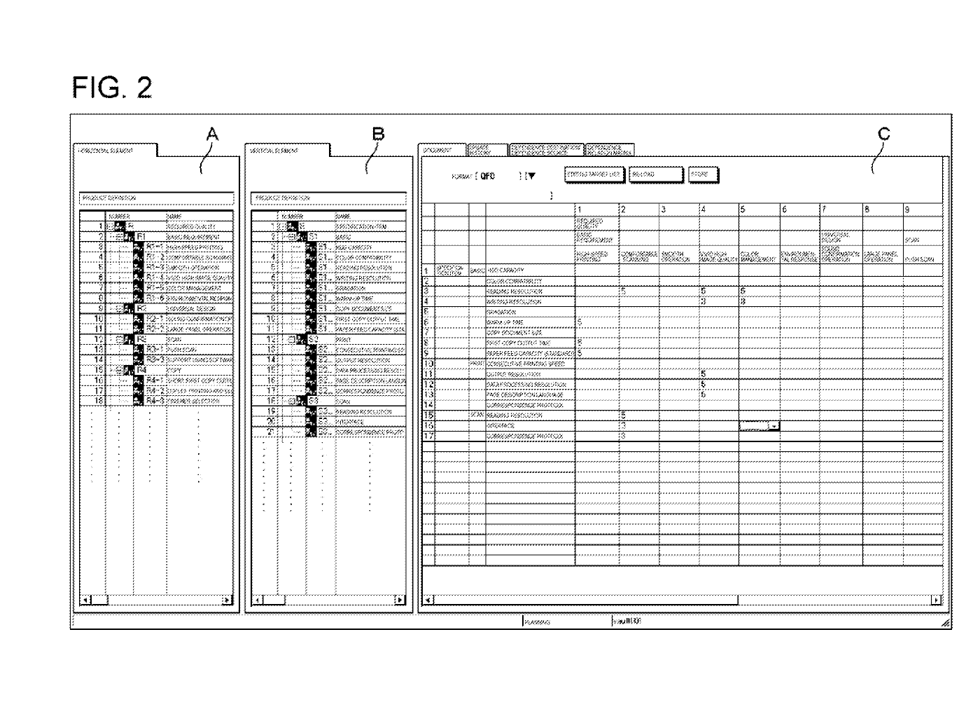

FIG. 2 shows an example of the two-dimensional matrix table displayed by the matrix display unit 15. The two-dimensional matrix table is displayed in a region C of FIG. 2. In the two-dimensional matrix table, the plurality of first specification items are displayed as vertical direction elements in a vertical column, and the plurality of first required qualities are displayed as horizontal direction elements in a horizontal row.

Meanwhile, the matrix display unit 15 can determine the vertical direction elements and the horizontal direction elements which are displayed in the two-dimensional matrix tables, in accordance with contents received by the vertical element selection reception unit 18 and the horizontal element selection reception unit 19 which are shown in FIG. 1. The vertical element selection reception unit 18 receives selection inputs for setting some or all of the one or plurality of first required qualities stored in the required quality storage unit 12 and the one or plurality of first specification items stored in the specification item storage unit 14 as the vertical direction elements of the two-dimensional matrix table. In addition, the horizontal element selection reception unit 19 receives selection inputs of setting some or all of the one or plurality of first required qualities stored in the required quality storage unit 12 and the one or plurality of first specification items stored in the specification item storage unit as the horizontal direction elements of the two-dimensional matrix table. The selection input can be realized using any input device such as a keyboard, a touch panel display, a scanner, or a microphone.

Herein, in a case of the example shown in FIG. 2, the horizontal element selection reception unit 19 determines elements displayed in a region A to be horizontal direction elements. In addition, the vertical element selection reception unit 18 determines elements displayed in a region B to be vertical direction elements.

In the region A, the words of “required quality” are set to a superordinate concept, and a plurality of detailed contents of the required quality are displayed in the form of a tree. In the region B, the wording of “specification item” is set to a superordinate concept, and a plurality of detailed contents of the specification item are displayed in the form of a tree.

The vertical element selection reception unit 18 and the horizontal element selection reception unit 19 may receive selection inputs of the vertical direction elements and selection inputs of the horizontal direction elements by receiving inputs for “displaying” or “not displaying” the elements displayed in the form of a tree in the regions A and B (in FIG. 2, required qualities and specification items) for each element. As described above, the elements displayed in the regions A and B are selected as the vertical direction elements and the horizontal direction elements, respectively. Meanwhile, means receiving such an input for selecting “display” and “non-display” is not particularly limited.

Meanwhile, the required quality reception unit 11 and the specification item reception unit 13 which are shown in FIG. 1 may receive inputs of the first required qualities and the first specification items from, for example, interfaces displayed in the regions A and B. That is, the required quality reception unit 11 and the specification item reception unit 13 may receive inputs of the first required qualities and the first specification items by receiving an input for adding a branch to the trees of the regions A and B and receiving an input for associating the required quality or the specification item with the branch. In addition, the required quality reception unit 11 and the specification item reception unit 13 may receive an input for deleting the inputs.

With such a configuration, the regions A and B of FIG. 2 function as interfaces by which the required quality reception unit 11 and the specification item reception unit 13 receive inputs of the first required qualities and the first specification items, and also function as interfaces by which the vertical element selection reception unit 18 and the horizontal element selection reception unit 19 receive selection inputs for the vertical direction element and the horizontal direction element.

Meanwhile, as another configuration, it is also possible to cause the regions A and B of FIG. 2 to function only as interfaces by which the vertical element selection reception unit 18 and the horizontal element selection reception unit 19 receive selection inputs for the vertical direction element and the horizontal direction element. That is, the required quality reception unit 11 and the specification item reception unit 13 receive in advance inputs of the first required qualities and the first specification items from an interface (design matter) which is different from the regions A and B of FIG. 2. In the regions A and B of FIG. 2, all the first required qualities and first specification items which are received in advance by the required quality reception unit 11 and the specification item reception unit 13 are displayed in the form of a tree so as to make it possible to individually select “display” and “non-display”. Similarly to the above, the vertical element selection reception unit 18 and the horizontal element selection reception unit 19 may receive selection inputs of the vertical direction elements and selection inputs of the horizontal direction elements by receiving inputs for “displaying” or “not displaying” the first required qualities and the first specification items which are displayed in the form of a tree. As described above, the elements displayed in the regions A and B are selected as the vertical direction elements and the horizontal direction elements, respectively.

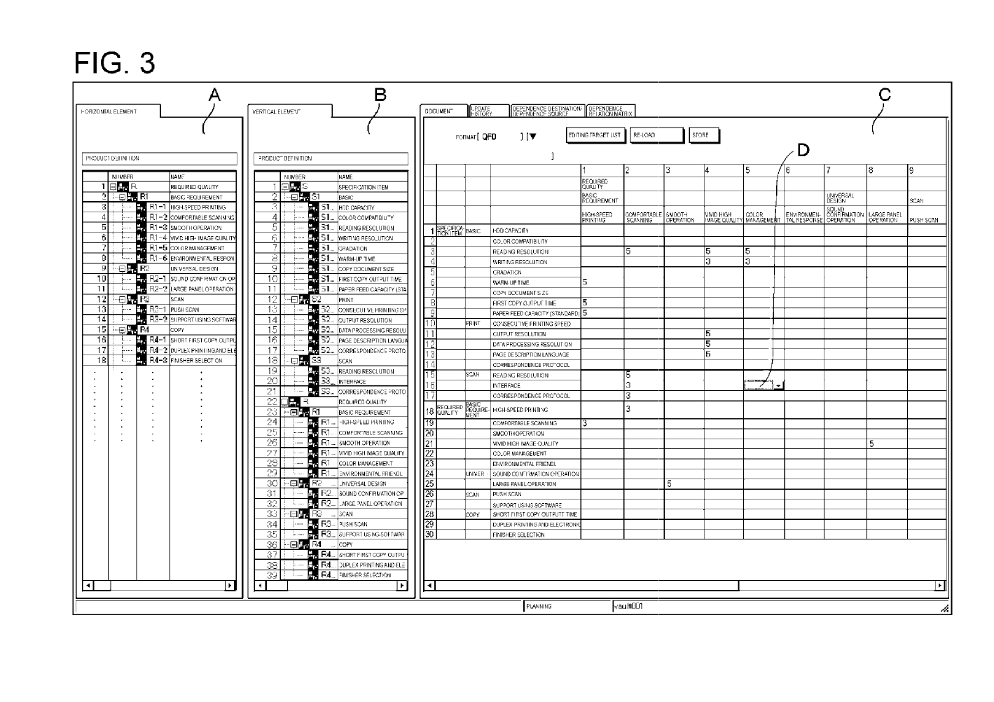

Here, FIG. 2 shows an example in which only some or all of the first specification items are displayed as the vertical direction elements and only some or all of the first required qualities are displayed as the horizontal direction elements. However, as shown in FIG. 3, it is also possible to display the first specification items and the first required qualities as the vertical direction elements. Although not shown in the drawing, it is also possible to display the first specification items and the first required qualities as the horizontal direction elements.

In this case, it is possible to cause the regions A and B to function as interfaces by which the required quality reception unit 11 and the specification item reception unit 13 receive inputs of the first required qualities and the first specification items and to function as interfaces by which the vertical element selection reception unit 18 and the horizontal element selection reception unit 19 receive selection inputs of the vertical direction elements and the horizontal direction elements.

In addition, it is also possible to cause the regions A and B to function only as interface by which the vertical element selection reception unit 18 and the horizontal element selection reception unit 19 receive selection inputs of the vertical direction elements and the horizontal direction elements. In this case, all the first required qualities and first specification items which are received in advance by the required quality reception unit 11 and the specification item reception unit 13 are displayed in the region A in the form of a tree so as to make it possible to individually select “display” and “non-display”. In addition, similarly, all the first required qualities and first specification items which are received in advance by the required quality reception unit 11 and the specification item reception unit 13 are displayed in the region B in the form of a tree so as to make it possible to individually select “display” and “non-display”. The vertical element selection reception unit 18 and the horizontal element selection reception unit 19 receive selection inputs of the vertical direction elements and selection inputs of the horizontal direction elements by receiving inputs for “displaying” or “not displaying” the first required qualities and the first specification items which are displayed in the form of a tree. As described above, the elements displayed in the regions A and B are selected as the vertical direction elements and the horizontal direction elements, respectively.

Meanwhile, the display in the form of a tree in the regions A and B is just an example, and it is also possible to perform display in an aspect different from a tree shape.

Referring back to FIG. 1, the relationship information reception unit 16 receives an input of relationship information with respect to a cell at an intersection between a first vertical direction element and a first horizontal direction element in the two-dimensional matrix table which is displayed by the matrix display unit 15.

The relationship information is a concept which is determined in accordance with the contents of the first vertical direction element which is an arbitrary element in the one or plurality of vertical direction elements and the first horizontal direction element which is an arbitrary element in the one or plurality of horizontal direction elements. For example, when a combination of the first vertical direction element and the first horizontal direction element is a set of the first required quality and the first specification item, relationship information is the strength of correspondence between the first required quality and the first specification item. In addition, when a combination of the first vertical direction element and the first horizontal direction element is a set of the first required quality and the first required quality, relationship information is the strength of correspondence between the first required quality and the first required quality. Further when a combination of the first vertical direction element and the first horizontal direction element is a set of the first specification item and the first specification item, relationship information is the strength of correspondence between the first specification item and the first specification item. The relationship information may be, for example, six-stage evaluation of 0 to 5 (0 has no correspondence and 5 has the strongest correspondence), and may be other aspects.

As shown in FIGS. 2 and 3, a designer of the first commercial product inputs relationship information into the two-dimensional matrix table. Meanwhile, when there are numerous vertical direction elements and horizontal direction elements which are displayed in the two-dimensional matrix table, the designer may feel burdened with an operation of inputting the relationship information while individually ascertaining the elements. In addition, the designer may unintentionally skip an arbitrary element, and thus there is a concern that input omission of relationship information may occur. In a case of the two-dimensional matrix table shown in FIG. 2, since it is possible to adjust the number of elements displayed in the two-dimensional matrix table by adjusting (selecting display or non-display) the elements displayed in the regions A and B, the designer can optimize the elements to be displayed in the two-dimensional matrix table by operating the regions A and B and reselecting the vertical direction elements and horizontal direction elements to be displayed.

Here, according to a two-dimensional matrix table, shown in FIG. 3, in which first required qualities are displayed as horizontal direction elements and not only first specification items but also first required qualities are displayed as vertical direction elements, the following effects are expected.

First, a designer's operation of inputting relationship information is performed, for example, according to the following flow. For example, the designer focuses on “high-speed printing” in the first required qualities listed as the horizontal direction elements. Then, the designer inputs predetermined values while determining, in order, the strength of correspondence between the “high-speed printing” (horizontal direction element) and each the first specification items listed as the vertical direction elements. When the determination of the strength of the correspondence between the “high-speed printing” (horizontal direction element) and each of all the first specification items (vertical direction elements) and the input of the relationship information are terminated, the designer then inputs relationship information while determining, in order, the strength of correspondence between the “high-speed printing” (horizontal direction element) and each of the first required qualities listed as the vertical direction elements. When the determination of the strength of the correspondence between the “high-speed printing” (horizontal direction element) and each of all the first required qualities (vertical direction elements) and the input of the relationship information are terminated, the designer focuses on “comfortable scanning” which is another horizontal direction element. Then, the same operation is advanced.

Here, as shown on FIG. 3, the designer inputs “5 (strong)” as a correspondence relationship between the “comfortable scanning” (first required quality) and “reading resolution” (first specification item), and sets a correspondence relationship between the “high-speed printing” (first required quality) and the “reading resolution” (first specification item) as “null value (no correspondence)”. Then, the designer inputs “3 (medium level)” as a correspondence relationship between the “comfortable scanning” (first required quality) and the “high-speed printing” (first required quality). As a result of reexamination of this triangle relation, the designer initially determines that there is no correspondence relationship between the “high-speed printing” (first required quality) and the “reading resolution” (first specification item), but can re-determine that there is an indirect correspondence relationship therebetween. It is possible to input again information having a predetermined correspondence relationship to a cell at an intersection between the “high-speed printing” (first required quality) and the “reading resolution” (first specification item) in the two-dimensional matrix table.

In this manner, according to this exemplary embodiment, the designer can determine the correspondence relationship between the first required quality and the first specification item while considering a correspondence relationship between the first required qualities and a correspondence relationship between the first specification items, and can input predetermined relationship information.

Referring back to FIG. 1, the relationship information storage unit 17 stores the relationship information received by the relationship information reception unit 16 in association with the first commercial product. For example, the first commercial product is given identification information such as a commercial product number, and the relationship information storage unit 17 stores relationship information in association with the identification information.

As described above, according to the information management device of this exemplary embodiment, it is also possible to input, to a two-dimensional matrix table, the strength of correspondence between the first required qualities and the strength of correspondence between the first specification items in addition to inputting the strength of correspondence between the first required quality and the first specification item. In this case, the designer can determine the strength of correspondence between the first required quality and the first specification item while also considering the strength of correspondence between the first required qualities and the strength of correspondence between the first specification items. As a result, it is possible to improve the accuracy of a process of converting the first required qualities to the first specification items.

According to the above description, the following information management method of this exemplary embodiment is also described.

The information management method causes a computer to execute a matrix display step of displaying a two-dimensional matrix table, displaying some or all of required qualities which are one or a plurality of qualities required for a first commercial product and one or a plurality of specification items associated with the first commercial product, as vertical direction elements, in a vertical column in the two-dimensional matrix table, and displaying some or all of the one or plurality of required qualities and the one or plurality of specification items, as horizontal direction elements, in a horizontal row in the two-dimensional matrix table, a relationship information reception step of receiving an input of relationship information indicating the strength of correspondence between the required quality and the specification item, the strength of correspondence between the required qualities, or the strength of correspondence between the specification items, with respect to a cell at an intersection between the first vertical direction element and the first horizontal direction element in the two-dimensional matrix table, in accordance with the contents of the first vertical direction element and the first horizontal direction element, and a relationship information storage step of storing the relationship information received in the relationship information reception step in association with the first commercial product.

In addition, for example, the information management device of this exemplary embodiment can be realized by installing the following program in a computer.

The program causes a computer to function as a required quality reception unit that receives inputs of required qualities which are one or a plurality of qualities required for a first commercial product, a required quality storage unit that stores the required qualities received by the required quality reception unit in association with the first commercial product, a specification item reception unit that receives inputs of one or a plurality of specification items associated with the first commercial product, a specification item storage unit that stores the specification items received by the specification item reception unit in association with the first commercial product, a matrix display unit that displays a two-dimensional matrix table, displays some or all of the one or plurality of required qualities stored in the required quality storage unit and the one or plurality of specification items stored in the specification item storage unit, as vertical direction elements, in a vertical column in the two-dimensional matrix table, and displays some or all of the one or plurality of required qualities stored in the required quality storage unit and the one or plurality of specification items stored in the specification item storage unit, as horizontal direction elements, in a horizontal row in the two-dimensional matrix table, a relationship information reception unit that receives an input of relationship information indicating the strength of correspondence between the required quality and the specification item, the strength of correspondence between the required qualities, or the strength of correspondence between the specification items, with respect to a cell at an intersection between a first vertical direction element and a first horizontal direction element in the two-dimensional matrix table, in accordance with the contents of the first vertical direction element and the first horizontal direction element, and a relationship information storage unit that stores the relationship information received by the relationship information reception unit in association with the first commercial product.

### Second Exemplary Embodiment

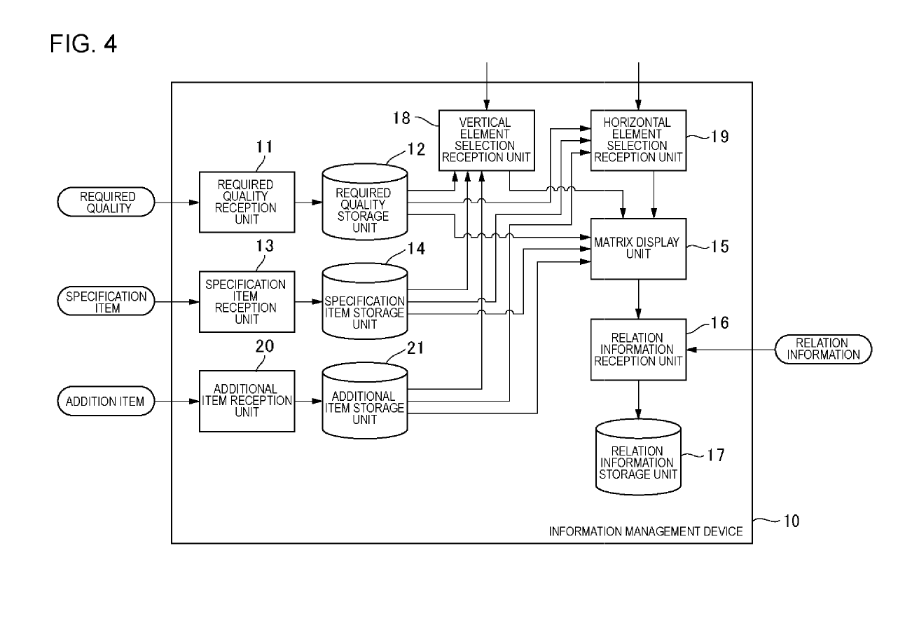

FIG. 4 shows an example of a functional block diagram of an information management device 10 according to this exemplary embodiment. As shown in the drawing, the information management device 10 includes a required quality reception unit 11, a required quality storage unit 12, a specification item reception unit 13, a specification item storage unit 14, a matrix display unit 15, a relationship information reception unit 16, a relationship information storage unit 17, an additional item reception unit 20, and an additional item storage unit 21. Meanwhile, the information management device 10 may further include a vertical element selection reception unit 18 and a horizontal element selection reception unit 19.

Hereinafter, the matrix display unit 15, the relationship information reception unit 16, the relationship information storage unit 17, the vertical element selection reception unit 18, the horizontal element selection reception unit 19, the additional item reception unit 20, and the additional item storage unit 21 will be described. Meanwhile, the description of the same parts as those in the first exemplary embodiment will be omitted. In addition, the configurations of the required quality reception unit 11, the required quality storage unit 12, the specification item reception unit 13, and the specification item storage unit 14 are similar to those in the first exemplary embodiment, and thus the description thereof will be omitted here.

The additional item reception unit 20 receives inputs of one or a plurality of additional items which are items classified into a category different from required qualities and specification items and which are associated with a first commercial product. For example, the additional item reception unit 20 may receive inputs of the additional items from the interfaces of the regions A and B shown in FIGS. 2 and 3. For example, a tree may be added at the same level as the words of the “required quality” and the “specification item” which are displayed in the trees, predetermined items may be added, and detailed contents of the items may be added under the items. Alternatively, the additional item reception unit 20 may receive inputs of the additional items from an interface different from the interfaces of the regions A and B. In the latter case, all of the additional items received by the additional item reception unit 20 may be displayed in the form of a tree in the region A and/or the region B so as to make it possible to individually select “display” and “non-display”. Similarly to the first exemplary embodiment, the vertical element selection reception unit 18 and the horizontal element selection reception unit 19 may receive selection inputs of vertical direction elements and selection inputs of horizontal direction elements by receiving inputs for “displaying” or “not displaying” first required qualities, first specification items, and the additional items which are displayed in the form of a tree. As described above, the elements displayed in the regions A and B are selected as the vertical direction elements and the horizontal direction elements, respectively.

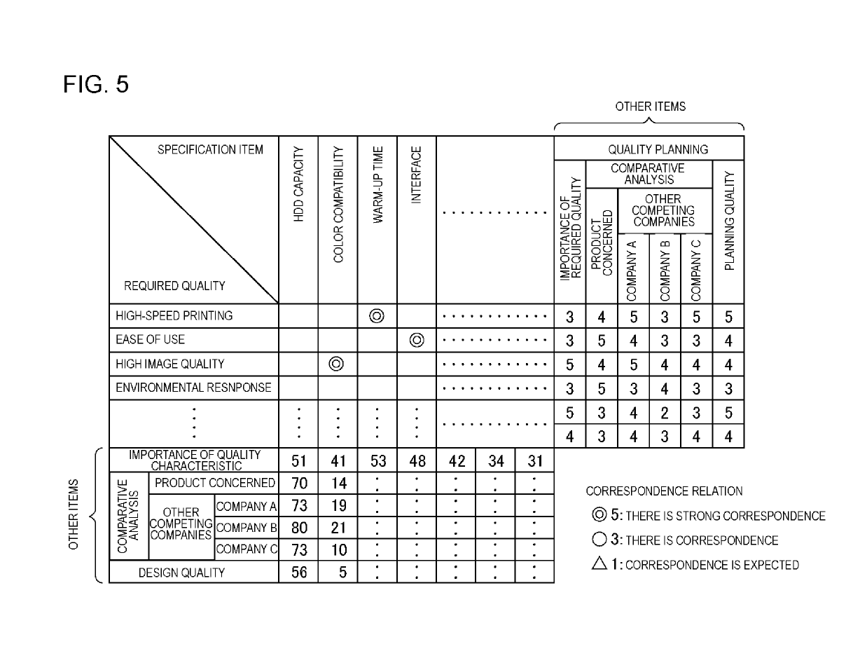

Here, an example of a two-dimensional matrix table displayed by the matrix display unit 15 of this exemplary embodiment is shown in FIG. 5. In the example shown in FIG. 5, a plurality of first specification items, as well as a plurality of other items, are displayed as horizontal direction elements. In addition, a plurality of first required qualities, as well as a plurality of other items, are displayed as vertical direction elements.

Here, an “importance of required quality” displayed as the horizontal direction element indicates how important a client (customer) thinks each required quality of a first commercial product (developed commercial product) is. Herein, as an example, evaluation is performed in five stages of 1 to 5. Regarding the importance, for example, questionnaires are conducted with respect to customers, and a designer can input the results thereof. In addition, a “comparative analysis” displayed as the horizontal direction element indicates results of customers' evaluation between one's own product (product concerned) and competing products of other competing companies. For example, one's own product can be an arbitrary product of one's own which is the same type as the developed commercial product. Herein, as an example, evaluation is performed in five stages of 1 to 5. Regarding the evaluation results, for example, questionnaires are conducted with respect to customers, and a designer can input the results thereof. In addition, a “planning quality” displayed as the horizontal direction element is a value which is set as a target value of the first commercial product (the present developed commercial product) and input by a designer on the basis of values of the importance of required quality and the comparative analysis.

Next, an “importance of quality characteristic” displayed as the vertical direction element indicates the respective importance of the plurality of first specification items. The importance indicates how strong the correspondence is between each of the first specification items and a first required quality group required for the first commercial product (the present developed commercial product). In other words, the importance indicates how important of the examination of each of the first specification items is in designing the first commercial product satisfying the first required quality group.

A score of the importance of quality characteristic may be input by making a designer input the strength of correspondence between the first specification item and the first required quality in the two-dimensional matrix table and then determining and inputting the importance of each first specification item with reference to the input result. Alternatively, when the designer inputs the strength of the correspondence between the first specification item and the first required quality in the two-dimensional matrix table, the importance of required characteristic of each of the plurality of first specification items may be automatically calculated in accordance with the input content. The matrix display unit 15 may display the values automatically calculated in the cells of the two-dimensional matrix table. For example, the sum of the input values is calculated for each first specification item, and the calculated value may be set as a required characteristic importance of each of the first specification items. In the example shown in FIG. 5, a correspondence relationship between the “color compatibility” which is the first specification item and the “high image quality” which is the first required quality is set to “5”. For this reason, “5” is added to a required characteristic importance of the “color compatibility” which is the first specification item. The importance of required characteristic of each of the first specification items may be calculated in accordance with the appropriate rule.

Meanwhile, means using the importance of required quality as a weighted value is also considered. For example, in the example shown in FIG. 5, a correspondence relationship between the “color compatibility” which is the first specification item and the “high image quality” which is the first required quality is set to “5”. In addition, an importance of required quality of the “high image quality” which is the first required quality is “5”. Accordingly, “25 (=5×5)” is added to an importance of required characteristic of the “color compatibility” which is the first specification item. The importance of required characteristic of each of the first specification items may be calculated in accordance with the appropriate rule.

In addition, the “comparative analysis” displayed as the vertical direction element indicates relative merits of performance between one's own product (product concerned) and the competing products of other competing companies. For example, one's own product can be an arbitrary product of one's own which is the same type as the developed commercial product. Meanwhile, regarding an evaluation method, a designer may perform evaluation on the basis of a maximum scale of 100 points, a maximum scale of 50 points, or the like and may input the evaluation results (see FIG. 5). Alternatively, although not shown in the drawing, a value capable of ascertaining details of each specification may be input. For example, regarding a specification item “HDD capacity”, an actual value such as 16 (MB), 32 (MB), or 64 (MB) may be input. Similarly, regarding the specification item “color compatibility”, an actual value such as 60,000 (colors), 260,000 (colors), or 16,770,000 (colors) may be input. Regarding a specification item “warm-up time”, an actual value such as 60 (seconds), 120 (seconds), 300 (seconds), or 360 (seconds) may be input. Regarding a specification item “interface”, an actual value such as 1 (type), 2 (types), 3 (types), or 5 (types) may be input.

In addition, a “design quality” displayed as the vertical direction element is a value which is set as a target value of the first commercial product (the present developed commercial product) and input by a designer on the basis of the importance of required quality and the comparative analysis.

Meanwhile, how the value of the “planning quality” as the horizontal direction element and the value of the “design quality” as the vertical direction element are to be set is a design matter, and all values do not necessarily exceed other competing companies. A designer can determine the value of the “planning quality” as the horizontal direction element and the value of the “design quality” as the vertical direction element in consideration of the importance of the items of the first commercial product (the present developed commercial product).

The relationship information storage unit 17 also stores information indicating the relation between the first required quality and the additional item and the relation between the first specification item and the additional item, which are described above, as the relationship information.

As described above, according to the information management device of this exemplary embodiment, a designer can easily ascertain the importance of the plurality of first specification items. As a result, it is possible to easily ascertain the priority of the plurality of first specification items in designing the first commercial product. In addition, it is possible to easily ascertain results for comparison and evaluation with respect to competing products for each first required quality and for each first specification item.

### Third Exemplary Embodiment

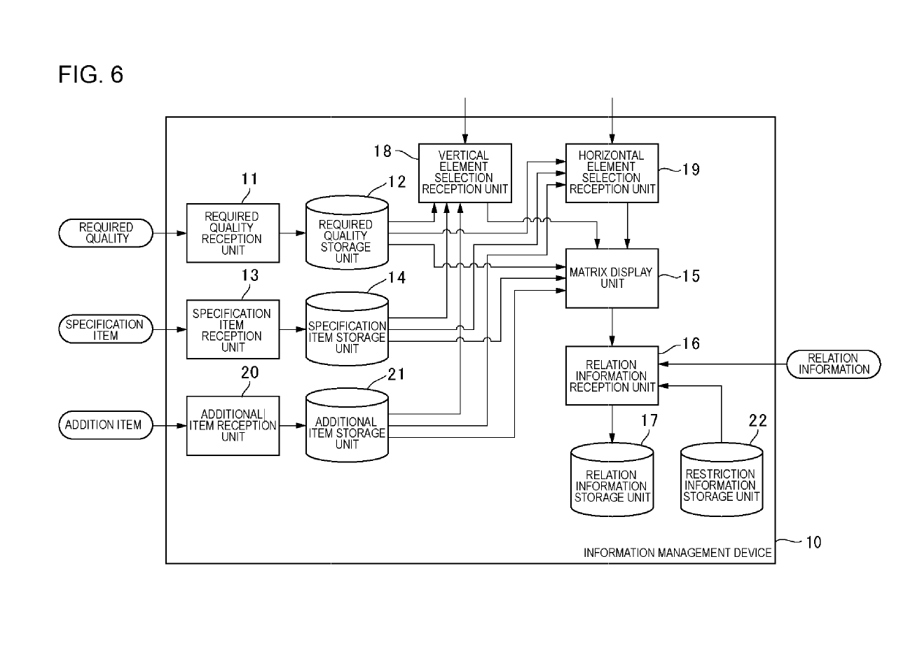

FIG. 6 shows an example of a functional block diagram of an information management device 10 of this exemplary embodiment. As shown in the drawing, the information management device 10 includes a required quality reception unit 11, a required quality storage unit 12, a specification item reception unit 13, a specification item storage unit 14, a matrix display unit 15, a relationship information reception unit 16, a relationship information storage unit 17, and a restriction information storage unit 22. Meanwhile, the information management device 10 may include an additional item reception unit 20 and an additional item storage unit 21, and may further include a vertical element selection reception unit 18 and a horizontal element selection reception unit 19. Alternatively, the information management device 10 may include the vertical element selection reception unit 18 and the horizontal element selection reception unit 19 instead of including the additional item reception unit 20 and the additional item storage unit 21.

Hereinafter, the limit information storage unit 22, the relationship information reception unit 16, and the matrix display unit 15 will be described. Meanwhile, the description of portions similar to those in the first exemplary embodiment and the second exemplary embodiment will be omitted. In addition, configurations of other units are similar to those in the first exemplary embodiment and the second exemplary embodiment, and thus the description thereof will be omitted here.

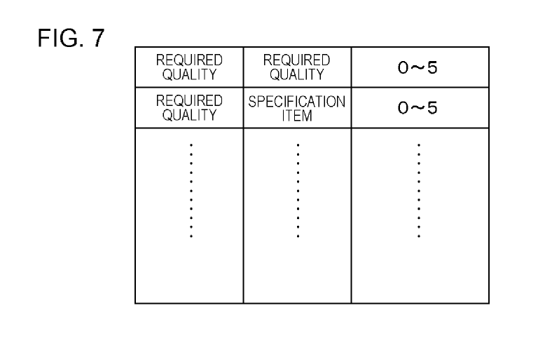

The restriction information storage unit 22 stores input value restriction information specifying values capable of being input to cells at intersections between first required qualities and first specification items in a two-dimensional matrix table displayed by the matrix display unit 15, cells at intersections between the first required qualities, and cells at intersections between the first specification items. For example, when the strength of correspondence between the first required quality and the first specification item is evaluated in six stages of 0 to 5, only values of 0 to 5 can be input to the cells at the intersections between the first required qualities and the first specification items. Similarly, when the strength of correspondence between the first required qualities is evaluated in six stages of 0 to 5, only values of 0 to 5 can be input to the cells at the intersections between the first required qualities and the first required qualities. Similarly, when the strength of correspondence between the first specification items is evaluated in six stages of 0 to 5, only values of 0 to 5 can be input to the cells at the intersections between the first specification items and the first specification items. The input value restriction information specifies such values capable of being input to the cells. For reference, an example of the input value restriction information is shown in FIG. 7. According to the input value restriction information shown in FIG. 7, it is specified that only values of 0 to 5 can be input to the cells at the intersections between the first required qualities and the first required qualities and the cells at the intersections between the first required qualities and the first specification items.

Meanwhile, the input value restriction information may further include information specifying values capable of being input to cells at intersections between the first required qualities and additional items and cells at intersections between the first specification items and the additional items.

When the relationship information reception unit 16 receives an input of relationship information for a first cell in the two-dimensional matrix table displayed by the matrix display unit 15, the unit first specifies the contents of a vertical direction element and a horizontal direction element. Thereafter, values capable of being input to the first cell are specified with reference to the input value restriction information stored in the restriction information storage unit 22, and only the specified values are permitted to be input.

For example, a case is considered in which an input for a cell where a cursor D is positioned is received in the two-dimensional matrix table displayed in the region C of FIG. 3. In this case, the relationship information reception unit 16 specifies the vertical direction element and the horizontal direction element which intersect at the cell where the cursor D is positioned. Herein, the first specification item and the first required quality are specified as the vertical direction element and the horizontal direction element, respectively. Thereafter, the relationship information reception unit 16 specifies values capable of being input to the cell with reference to, for example, the input value restriction information shown in FIG. 7. Herein, values of 0 to 5 are specified. For this reason, the relationship information reception unit 16 permits only the values of 0 to 5 (herein, the relation of null value=0 is established) with respect to the cell where the cursor D is positioned. Meanwhile, the relationship information reception unit 16 may display values which are permitted to be input by, for example, a drop-down list and may receive an input for selecting any one value.

According to this exemplary embodiment, it is possible to prevent a disadvantage in which a designer erroneously inputs a value, which is not specified, to the two-dimensional matrix table. As a result, it is possible to improve the accuracy of a process of converting the first required qualities to the first specification items.

### Fourth Exemplary Embodiment

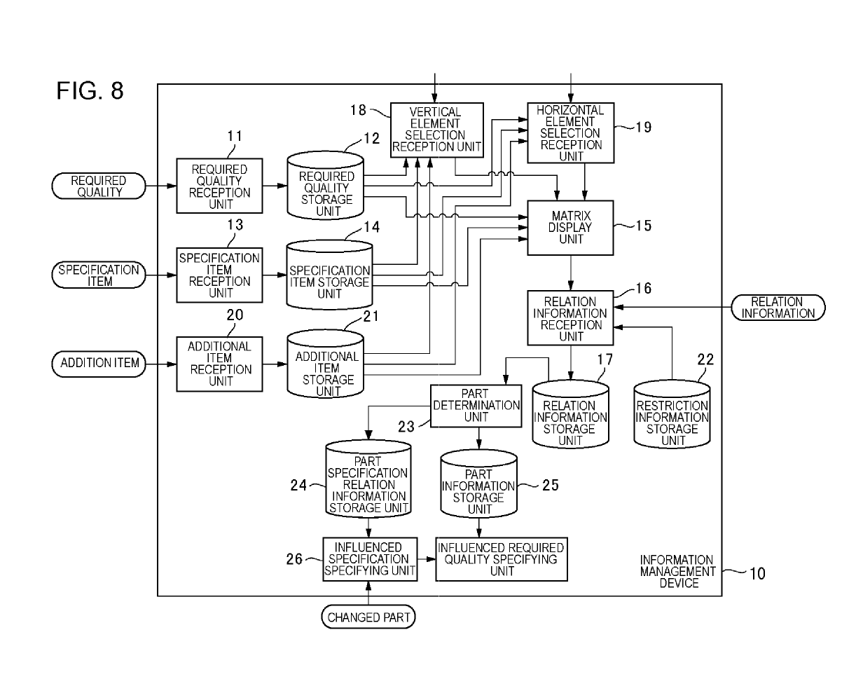

FIG. 8 shows an example of a functional block diagram of an information management device 10 of this exemplary embodiment. As shown in the drawing, the information management device 10 includes a required quality reception unit 11, a required quality storage unit 12, a specification item reception unit 13, a specification item storage unit 14, a matrix display unit 15, a relationship information reception unit 16, a relationship information storage unit 17, a part determination unit 23, a part specification relationship information storage unit 24, apart information storage unit 25, an influenced specification specifying unit 26, and an influenced required quality specifying unit 27. Meanwhile, the information management device 10 may include an additional item reception unit 20 and an additional item storage unit 21, and may further include a vertical element selection reception unit 18 and a horizontal element selection reception unit 19, and/or a restriction information storage unit 22. Alternatively, the information management device 10 may include the vertical element selection reception unit 18 and the horizontal element selection reception unit 19, and/or the restriction information storage unit 22, instead of including the additional item reception unit 20 and the additional item storage unit 21.

Hereinafter, configurations of a part determination unit 23, a part specification relationship information storage unit 24, a part information storage unit 25, an influenced specification specifying unit 26, and an influenced required quality specifying unit 27 will be described. Meanwhile, configurations of other units are similar to those in the first exemplary embodiment, the second exemplary embodiment, and the third exemplary embodiment, and thus the description thereof will be omitted here.

The part determination unit 23 determines parts of a first commercial product on the basis of relationship information stored in the relationship information storage unit 17. The parts can be determined using a technique disclosed in Non-Patent Document 1. Hereinafter, an example of a process of determining parts of a developing device included in a multifunction machine will be described.

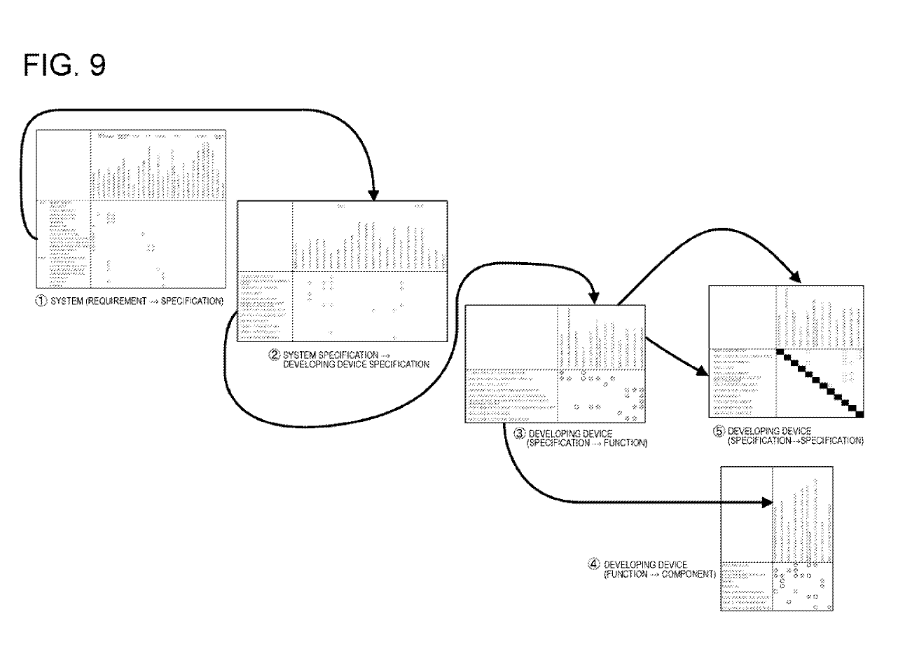

When the part determination unit 23 receives inputs of a plurality of specifications of the developing device from a designer, the unit displays a two-dimensional matrix table of specifications of the multifunction machine and specifications of the developing device, as shown by “system specification→developing device specification” in FIG. 9. Then, the part determination unit 23 receives an input of information indicating a correspondence relationship between each specification of the multifunction machine and each specification of the developing device from a designer. In addition, when the part determination unit 23 receives inputs of a plurality of functions of the developing device from the designer, the unit displays a two-dimensional matrix table of the specifications and the functions of the developing device, as shown by “developing device (specification→function)” in FIG. 9. Then, the part determination unit 23 receives an input of information indicating a correspondence relationship between each specification and each function from the designer. In addition, the part determination unit 23 displays a two-dimensional matrix table in which the specifications of the developing device are arranged in horizontal and vertical directions, as shown by “developing device (specification→specification)” in FIG. 9. Then, the part determination unit 23 receives an input of information indicating a correspondence relationship between the specifications of the developing device. In addition, when the part determination unit 23 receives inputs of a plurality of components (units) of the developing device from the designer, the unit displays a two-dimensional matrix table of the functions and the components of the developing device as shown by “developing device (function→component)” in FIG. 9. Then, the part determination unit 23 receives an input of information indicating a correspondence relationship between each function and each unit of the developing device from the designer. Meanwhile, in the tables shown in FIG. 9, although vertical lines and horizontal lines are hidden in order to make the display clear, it is possible to actually form a two-dimensional matrix table in which vertical lines and horizontal lines are displayed.

Meanwhile, although not shown in the drawing, after the designer inputs the above-described correspondence relationship in each two-dimensional matrix table, the designer may be able to determine and input an importance, a target value, and the like of each item as described in the second exemplary embodiment. For example, after the designer inputs information indicating a correspondence relationship between each specification of the multifunction machine and each specification of the developing device in the “system specification→developing device specification” shown in FIG. 9, the designer may set and input a target value of each specification of the developing device on the basis of the input contents and a target value (“design quality” of FIG. 5) of each specification of the multifunction machine which is set in the previous step. Similarly, after the designer inputs information indicating a correspondence relationship between each specification and each function of the developing device in the “developing device (specification→function)” shown in FIG. 9, the designer may set and input a target value of each function of the developing device on the basis of the input contents and the target value of each specification of the developing device. Similarly, after the designer inputs information indicating a correspondence relationship between each function and each component of the developing device in the “developing device (function→component)” shown in FIG. 9, the designer may set and input a target value of each component (unit) of the developing device on the basis of the input contents and the target value of each function of the developing device. Thereafter, the designer determines parts of each component (unit) on the basis of the target value of each component (unit) and inputs the parts to the part determination unit 23. The part determination unit 23 acquires the input parts as component parts of the first commercial product.

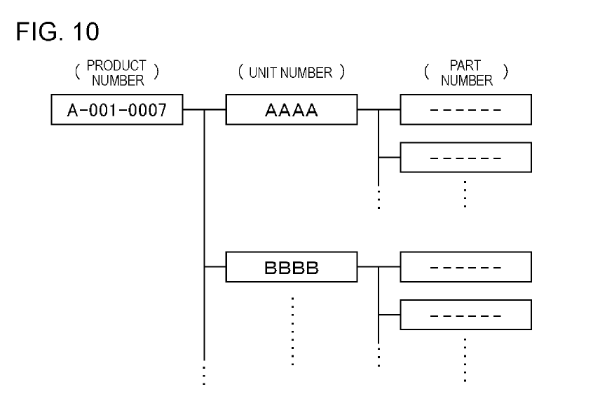

The part information storage unit 25 stores part information indicating the component parts of the first commercial product which are determined by the part determination unit 23 on the basis of the relationship information stored in the relationship information storage unit 17. An example of the part information is shown in FIG. 10. The part information displays the component parts of the first commercial product in the form of a tree. Here, a “product number” is an identification number of the first commercial product. A “unit number” is a number of a unit constituting the first commercial product, and a “part number” is a number of a part constituting each unit.

The part specification relationship information storage unit 24 stores part specification relationship information for specifying a correspondence relationship between each first specification item and each component part. Specifically, the part specification relationship information storage unit 24 stores a plurality of pieces of data (for example, “system specification→developing device specification”, “developing device (specification→function)”, “developing device (specification→specification)”, and “developing device (function→component)” shown in FIG. 9) which are created by the part determination unit 23 on the basis of a designer's input in order to perform a breakdown into a component (unit) using the first specification item as a start.

When some of the component parts of the first commercial product are changed to other parts, the influenced specification specifying unit 26 specifies the first specification item affected by the change. Specifically, first, the influenced specification specifying unit 26 acquires information (part number) for specifying the component part to be changed. Thereafter, the unit specifies a unit including the part with reference to the part information (see FIG. 10) which is stored in the part information storage unit 25. Subsequently, the influenced specification specifying unit 26 specifies a function having a correspondence relationship with the specified unit (component) with reference to the information (for example, “developing device (function→component)” of FIG. 9) which is stored in the part specification relationship information storage unit 24, and then specifies the first specification item having a correspondence relationship with the specified function using other pieces of information stored in the part specification relationship information storage unit 24 in a similar manner.

The influenced required quality specifying unit 27 specifies the first required quality affected by the change in the component part, using the relationship information (see FIG. 5) which is stored in the relationship information storage unit 17 and the first specification item affected by the change in the component part which is specified by the influenced specification specifying unit 26. Specifically, the influenced required quality specifying unit 27 specifies the first required quality having a correspondence relationship with the first specification item with reference to the relationship information (see FIG. 5).

As described above, according to this exemplary embodiment, a designer can easily ascertain the first required quality affected by the change in the component part.

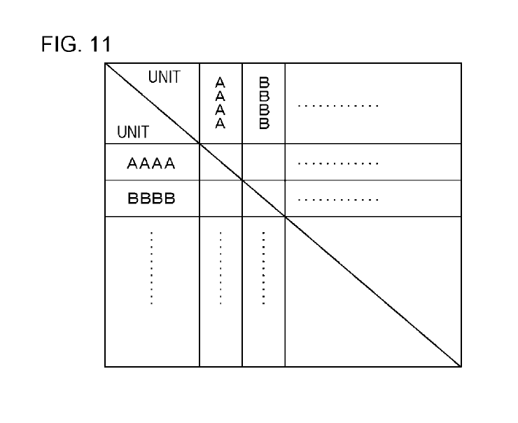

Meanwhile, the information management device 10 of this exemplary embodiment may create and store information indicating a correspondence relationship between units as shown in FIG. 11. The information may be created by a designer using the interfaces shown in FIGS. 2 and 3 and may be stored in the information management device 10. Regarding the correspondence relationship between the units, for example, when the design of a first unit is changed (change in parts, or the like) and when it is necessary to readjust the design of a second unit, the first unit and the second unit can be considered to have a correspondence relation.

When the information management device 10 of this exemplary embodiment stores the above-described information indicating the correspondence relationship between the units, the following process can be realized. For example, when some of the component parts of the first commercial product are changed to other parts, the influenced specification specifying unit 26 specifies a unit including the parts with reference to the part information (see FIG. 10) which is stored in the part information storage unit 25, and specifies a unit having a correspondence relationship with the specified unit with reference to the information (see FIG. 11) which indicates the correspondence relationship between the units. Thereafter, as described above, the influenced specification specifying unit 26 specifies functions having correspondence relations with all the units (unit including the changed parts and a unit having a correspondence relationship with the unit) which are specified by the influenced specification specifying unit 26 with reference to the part specification relationship information (FIG. 9) which is stored in the part specification relationship information storage unit 24, and then specifies the first specification items having correspondence relations with the functions. Then, the influenced required quality specifying unit 27 specifies the first required qualities having correspondence relations with the first specification items with reference to the relationship information (see FIG. 5). In this case, it is possible to specify the first required qualities affected by the change in the parts with a higher level of accuracy.

The application is based on Japanese Patent Application No. 2012-008499 filed on Jan. 18, 2012, the content of which is incorporated herein by reference.

1. An information management device comprising:
a required quality reception unit that receives inputs of required qualities which are one or a plurality of qualities required for a first commercial product;
a required quality storage unit that stores the required qualities received by the required quality reception unit in association with the first commercial product;
a specification item reception unit that receives inputs of one or a plurality of specification items associated with the first commercial product;
a specification item storage unit that stores the specification items received by the specification item reception unit in association with the first commercial product;
a matrix display unit that displays a two-dimensional matrix table, displays some or all of the one or plurality of required qualities stored in the required quality storage unit and the one or plurality of specification items stored in the specification item storage unit, as vertical direction elements, in a vertical column in the two-dimensional matrix table, and displays some or all of the one or plurality of required qualities stored in the required quality storage unit and the one or plurality of specification items stored in the specification item storage unit, as horizontal direction elements, in a horizontal row in the two-dimensional matrix table;
a relationship information reception unit that receives an input of relationship information indicating strength of correspondence between the required quality and the specification item, strength of correspondence between the required qualities, or strength of correspondence between the specification items, with respect to a cell at an intersection between a first vertical direction element and a first horizontal direction element in the two-dimensional matrix table, in accordance with contents of the first vertical direction element and the first horizontal direction element; and
a relationship information storage unit that stores the relationship information received by the relationship information reception unit in association with the first commercial product.

2. The information management device according to claim 1, further comprising:
a vertical element selection reception unit that receives selection inputs for setting some or all of the one or plurality of required qualities stored in the required quality storage unit and the one or plurality of specification items stored in the specification item storage unit as the vertical direction elements; and
a horizontal element selection reception unit that receives selection inputs for setting some or all of the one or plurality of required qualities stored in the required quality storage unit and the one or plurality of specification items stored in the specification item storage unit to the horizontal direction elements,
wherein the matrix display unit displays the vertical direction elements and the horizontal direction elements which are specified by the selection inputs, in the two-dimensional matrix table.

3. The information management device according to claim 1, further comprising:
an additional item reception unit that receives inputs of one or plurality of additional items which are items that are classified into a category different from those of the required qualities and the specification items and that have to be considered in designing the first commercial product; and
an additional item storage unit that stores the additional items received by the additional item reception unit in association with the first commercial product,
wherein the matrix display unit is capable of displaying the one or plurality of additional items stored in the additional item storage unit as the vertical direction elements and/or the horizontal direction elements in the two-dimensional matrix table, and
wherein the relationship information reception unit is capable of further receiving an input of information indicating a relation between the required quality and the additional item or a relation between the specification item and the additional item, as the relationship information.

4. The information management device according to claim 3, further comprising:
a vertical element selection reception unit that receives selection inputs for setting some or all of the one or plurality of required qualities stored in the required quality storage unit, the one or plurality of specification items stored in the specification item storage unit, and the one or plurality of additional items stored in the additional item storage unit as the vertical direction elements; and
a horizontal element selection reception unit that receives selection inputs for setting some or all of the one or plurality of required qualities stored in the required quality storage unit, the one or plurality of specification items stored in the specification item storage unit, and the one or plurality of additional items stored in the additional item storage unit, as the horizontal direction elements,
wherein the matrix display unit displays the vertical direction elements and the horizontal direction elements which are specified by the selection inputs, in the two-dimensional matrix table.

5. The information management device according to claim 1, further comprising:
a restriction information storage unit that stores input value restriction information specifying values capable of being input to cells at intersections between the required qualities and the specification items, cells at intersections between the required qualities, and cells at intersections between the specification items in the two-dimensional matrix table,
wherein when the relationship information reception unit receives an input of the relationship information for a first cell in the two-dimensional matrix table, the unit first specifies contents of the vertical direction elements and the horizontal direction elements, and specifies values capable of being input to the first cell with reference to the input value restriction information, and then permits only the specified values to be input.

6. The information management device according to claim 3, further comprising:
a restriction information storage unit that stores input value restriction information specifying values capable of being input to cells at intersections between the required qualities and the specification items, cells at intersections between the required qualities, and cells at intersections between the specification items in the two-dimensional matrix table,
wherein when the relationship information reception unit receives an input of the relationship information for a first cell in the two-dimensional matrix table, the unit first specifies contents of the vertical direction elements and the horizontal direction elements, and specifies values capable of being input to the first cell with reference to the input value restriction information, and then permits only the specified values to be input,
wherein the input value restriction information stored in the restriction information storage unit also includes information specifying values capable of being input to cells at intersections between the required qualities and the additional items and cells at intersections between the specification items and the additional items.

7. The information management device according to claim 1, further comprising:
a part information storage unit that stores part information indicating component parts of the first commercial product which is determined on the basis of the relationship information stored in the relationship information storage unit;
a part specification relationship information storage unit that stores part specification relationship information for specifying a correspondence relationship between each of the specification items and each of the component parts;
an influenced specification specifying unit that, when some of the component parts of the first commercial product are changed to other parts, specifies the specification items affected by the change with reference to the part specification relationship information; and
an influenced required quality specifying unit that specifies the required qualities affected by the change in the component parts, using the relationship information stored in the relationship information storage unit and the specification items specified by the influenced specification specifying unit.

8. A non-transitory storage medium storing a program causing a computer to function as:
a required quality reception unit that receives inputs of required qualities which are one or a plurality of qualities required for a first commercial product;
a required quality storage unit that stores the required qualities received by the required quality reception unit in association with the first commercial product;
a specification item reception unit that receives inputs of one or a plurality of specification items associated with the first commercial product;
a specification item storage unit that stores the specification items received by the specification item reception unit, in association with the first commercial product;
a matrix display unit that displays a two-dimensional matrix table, displays some or all of the one or plurality of required qualities stored in the required quality storage unit and the one or plurality of specification items stored in the specification item storage unit, as vertical direction elements, in a vertical column in the two-dimensional matrix table, and displays some or all of the one or plurality of required qualities stored in the required quality storage unit and the one or plurality of specification items stored in the specification item storage unit, as horizontal direction elements, in a horizontal row in the two-dimensional matrix table;
a relationship information reception unit that receives an input of relationship information indicating strength of correspondence between the required quality and the specification item, strength of correspondence between the required qualities, or strength of correspondence between the specification items, with respect to a cell at an intersection between a first vertical direction element and a first horizontal direction element in the two-dimensional matrix table, in accordance with contents of the first vertical direction element and the first horizontal direction element; and
a relationship information storage unit that stores the relationship information received by the relationship information reception unit in association with the first commercial product.

9. An information management method executed by a computer, the method comprising:
a matrix display step of displaying a two-dimensional matrix table, displaying some or all of required qualities which are one or a plurality of qualities required for a first commercial product and one or a plurality of specification items associated with the first commercial product, as vertical direction elements, in a vertical column in the two-dimensional matrix table, and displaying some or all of the one or plurality of required qualities and the one or plurality of specification items, as horizontal direction elements, in a horizontal row in the two-dimensional matrix table;
a relationship information reception step of receiving an input of relationship information indicating strength of correspondence between the required quality and the specification item, strength of correspondence between the required qualities, or strength of correspondence between the specification items, with respect to a cell at an intersection between a first vertical direction element and a first horizontal direction element in the two-dimensional matrix table, in accordance with contents of the first vertical direction element and the first horizontal direction element; and
a relationship information storage step of storing the relationship information received in the relationship information reception step in association with the first commercial product.
